(19) United States
(12) Patent Application Publication
(10) Pub. No.: US 2008/0244517 A1
(43) Pub. Date: Oct. 2, 2008

(54) HORIZONTAL AND VERTICAL FILTERING OF MULTI-DOMAIN BUSINESS APPLICATION MODELS

(75) Inventor: Nir Rostoker, Kiriat Bialik (IL)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/691,255

(22) Filed: Mar. 26, 2007

(51) Int. Cl. G06F 9/44

(52) U.S. Cl. 717/120

(57) ABSTRACT

This disclosure relates to methods, systems, and software for horizontal and vertical filtering of business application models. Such software may identify a first modeling domain and a second modeling domain for a business application. The software can then apply a filter to at least the first modeling domain to determine a subset of the first and second modeling domains and present the subset of one of the modeling domains to a client. In some situations, each modeling domain may be a UI domain, a business process domain, or a data domain. Further, the first modeling domain can represent the particular domain in a first logical layer and the second modeling domain can represent the same domain in a second logical layer. Moreover, the software can apply any suitable number of filters, whether vertical and/or horizontal, to any number of appropriate domains and layers.

### TECHNICAL FIELD

This disclosure relates to computer systems and methods and, more particularly, to methods, systems, and software for horizontal and vertical filtering of multi-domain business application models.

### BACKGROUND

Enterprise software systems are generally large and complex. Such systems can require many different components, distributed across many different hardware platforms, possibly in several different geographical locations. In order to design, configure, update or implement an enterprise software system, one is generally required to understand details of the system at varying levels, depending on his role in designing, managing or implementing the system. For example, a systems administrator may need a high-level technical understanding of how various software modules are installed on physical hardware, such as a server device or a network, and how those software modules interact with other software modules in the system. A person responsible for configuring the software may utilize a high-level functional understanding of the operations that each functional component provides. An application designer may utilize a low-level technical understanding of the various software interfaces that portions of the application require or implement. And an application developer may utilize a detailed understanding of the interfaces and functionality he is implementing in relation to the remainder of the system.

Within a development environment, an application can be developed using modeling systems. In general, these models can specify the types of development objects or components that can be used to build applications, as well as the relationships that can be used to connect those components. In an object-oriented architecture, for example, a defined application can include a combination of various data objects and resources (i.e., development objects). In that example, relationships among the development objects can include a relationship indicating that one data object inherits characteristics from another data object. Another example architecture is the model-view-controller (MVC) architecture. Applications built using the MVC architecture typically include three different types of components—models, which store data such as application data; views, which display information from one or more models; and controllers, which can relate views to models, for example, by receiving events (e.g., events raised by user interaction with one or more views) and invoking corresponding changes in one or more models. When changes occur in a model, the model can update its views. Data binding can be used for data transport between a view and its associated model or controller. For example, a table view (or a table including cells that are organized in rows and columns) can be bound to a corresponding table in a model or controller. Such a binding indicates that the table is to serve as the data source for the table view and, consequently, that the table view is to display data from the table. Continuing with this example, the table view can be replaced by another view, such as a graph view. If the graph view is bound to the same table, the graph view can display the data from the table without requiring any changes to the model or controller. In the MVC architecture, development objects can include models, views, controllers, and components that make up the models, views, and controllers. For example, application data in a model can be an example of a component that is a development object.

To graphically model an application, such that a combination of abstract, graphical representations represent the components of the application and the relationships between those components, a developer typically uses a drawing tool, such as Microsoft Visio, that provides abstract representations and tools for manipulating and/or generating abstract representations. For example, a user of the drawing tool (such as a developer) can choose to use a circle (or any other suitable abstract representation or model) to represent a class (such as a class defined in the C++ or other object-oriented programming language) of an application developed under the object-oriented architecture. The circle that represents a development object can include data from the development object. For example, a name of a class (i.e., data from a development object) can be entered in a text box that is part of the circle, and that name can be displayed in the center of the circle. In addition to drawing tools, the developer can also use other graphical tools to generate graphical representations and models (e.g., Unified Modeling Language (UML) diagrams or Business Process Execution Languages (BPEL)) from application code or vice versa.

### SUMMARY

This disclosure relates to methods, systems, and software for horizontal and vertical filtering of multi-domain business application models. For example, such software may comprise computer-readable instructions operable when executed to identify a first modeling domain and a second modeling domain for a business application. The software can then apply a filter to at least the first modeling domain to determine a subset of the first and second modeling domains and present the subset of one of the modeling domains to a client. In some situations, each modeling domain may be a user interface (UI) domain, a business process domain, or a data domain. Further, the first modeling domain can represent the particular domain in a first logical layer and the second modeling domain can represent the same domain in a second logical layer. In other cases, the first modeling domain can represent the particular domain in a first logical layer (such as the business process domain) and the second modeling domain can represent one of remaining domains in the first logical layer (such as the UI domain or the data domain). Moreover, in some implementations, the software can apply any suitable number of filters, whether vertical and/or horizontal, to any number of appropriate domains and layers.

The foregoing example software—as well as other disclosed processes—may also be computer implementable methods. Moreover, some or all of these aspects may be further included in respective systems or other devices for executing, implementing, or otherwise supporting horizontal and vertical filtering of multi-domain business application models. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for horizontal and vertical filtering of graphical user interface (GUI) modeling domains in accordance with one embodiment of the present disclosure;

FIG. 2A depicts an example modeling environment in accordance with one embodiment of FIG. 1;

FIG. 2B depicts a simplified process for mapping a model representation to a runtime representation using the example modeling environment of FIG. 2A or some other modeling environment;

FIG. 2C provides an example model comprising a plurality of layers, which include a number of modeling domains in accordance with one embodiment of FIG. 1;

FIG. 2D provides an example of the model layers of FIG. 2C;

FIG. 3 is a flowchart illustrating an example method for horizontal and vertical filtering of modeling domains in accordance with one embodiment of the present disclosure; and

FIGS. 4A-G illustrate example filter views in accordance with one embodiment of the present disclosure.

### DETAILED DESCRIPTION

This disclosure generally describes an example environment 100 for creating, managing, and implementing horizontal and vertical filtering for multi-domain business models. At a high level, the model is a representation of a software system, part of a software system, or an aspect of a software system. The model can be associated with one or more views. A view of the model represents a subset of the information in the model. For purposes of discussion, the term “model” will be used to refer to both the model or a view of the model. The model can be used in a software development process to describe or specify a software application, or parts or aspects of a software application, for developers implementing or modifying the application. The model specifies the design to a useful level of detail or granularity. In this way, a compliant implementation or deployment of the modeled functionality can conform to the specification represented by the model. For example, the model may represent a sequence of steps, executed to achieve a business result. According to the particular design, each step can result in the change of state of a business object. Business processes can be part of, triggered by, and superior to other business processes. Business processes can be modeled in a hierarchy. As described herein, the business process hierarchy includes a requirements definition, design specification, and implementation description level, but other ways of defining a business process or other view hierarchy are possible. Thus, the models described herein can be written in description notations appropriate for process modeling. As described in more detail below, the model may include any number of logical layers, each of which include one or more domains and represent a logical category of modeling such as high level business views, system independent process views, and implementation views. Each layer may be considered a sub-model or a model in its own right that can be bound with other layers/models. Moreover, each logical layer can—in some cases—be bound with a plurality of lower layers, such as one system independent process view being bound to a number of disparate, but similar, implementation views. Often, the domains in one layer substantially match the domains in other bound layers.

To facilitate the ease of understanding or utilization of such models, environment 100 may provide various filters 106 based on different tasks, personal preferences, and personal technical and business knowledge of a model. For example, environment 100 may provide a user with different (horizontal or vertical) filters that allow him to easily find parts of the business process for his specific task or need. Such filters may also support different preferences of different user types. Using one or more of these filters, the user can drill down into more technical (or lower) levels or focus on the higher levels which are less technical and more business driven.

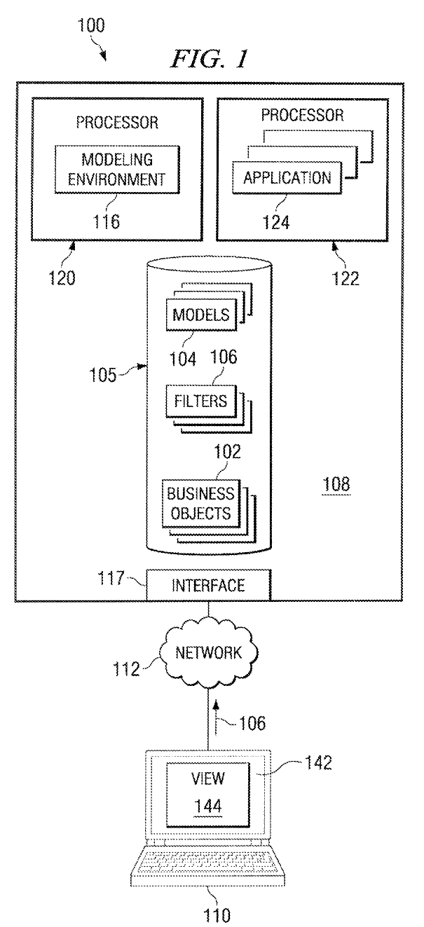

With respect to example FIG. 1, environment 100 is typically a distributed client/server system that spans one or more networks such as 106. As described above, rather than being delivered as packaged software, portions of environment 100 may represent a hosted solution, often for an enterprise or other small business, that may scale cost-effectively and help drive faster adoption. In this case, portions of the hosted solution may be developed by a first entity, while other components are developed by a second entity. Moreover, the processes or activities of the hosted solution may be distributed amongst these entities and their respective components. In some embodiments, environment 100 may be in a dedicated enterprise environment—across a local area network or subnet—or any other suitable environment without departing from the scope of this disclosure.

Turning to the illustrated embodiment, environment 100 includes or is communicably coupled with server 108 and one or more clients 110, at least some of which communicate across network 112. Server 108 comprises an electronic computing device operable to receive, transmit, process and store data associated with environment 100. For example, server 108 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 1 provides merely one example of computers that may be used with the disclosure. Each computer is generally intended to encompass any suitable processing device. For example, although FIG. 1 illustrates one server 108 that may be used with the disclosure, environment 100 can be implemented using computers other than servers, as well as a server pool. Indeed, server 108 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Server 108 may be adapted to execute any operating system including Linux, UNIX, Windows Server, or any other suitable operating system. According to one embodiment, server 108 may also include or be communicably coupled with a web server and/or a mail server.

Server 108 often includes local memory 105. Memory 105 may include any memory or database module and may take the form of volatile or non-volatile memory including, without limitation, magnetic media, optical media, random access memory (RAM), read-only memory (ROM), removable media, or any other suitable local or remote memory component. Illustrated memory 105 includes one or more data objects 102 and, at some point, one or more modeled elements 104. But memory 105 may also include any other appropriate data such as HTML files or templates, data classes or object interfaces, unillustrated software applications or sub-systems, and others. For example, memory 105 may include pointers or other references to data objects 102 that were published to a location remote from server 108. In this way, a local developer or non-technical business analyst may use a remote model 104 or modeling domain to efficiently supplement the particular aspect that he is modeling or viewing.

Data objects 102 are elements for information storage in object-oriented computing systems. Data objects can describe the characteristics of an item using a series of data fields that, for example, can correspond to described characteristics. Typically, a programmer will predefine standard object classes, referred to in the present specification as object types, that are hardcoded into a set of machine-readable instructions for performing operations. Object types are blueprints for describing individual objects using a defined set of class attributes (or properties). Instantiated objects that are members of such standard object types can be applied in a variety of different data processing activities by users, for example, customers who are largely unaware of the structure of the standard object types. Put another way, the data objects 102 are generally logical structures that can be modeled and then instantiated upon deployment to store particular data. Business objects may be a particular form of data object that a developer can utilize or reference in the front-end of any business or other modeled application.

According to some embodiments, the developer (or other analyst) may use a model-driven development environment 116 to compose an application using models 104 of business logic or processes, data objects 102, user interfaces, and so forth without having to write much, if any, code. Moreover, these models can include or be different logical layers of abstraction including system-specific, system-independent, business-independent instances. Indeed, one of these logical layers may represent actual code or modules, whether source or executable, to assist developers. These layers of abstractions can include different domains that provide different views on the particular abstraction, including graphical interfaces, business processes or logic, and data flow. In some circumstances, some or all of these models 104 may conform to a particular metamodel or metadata infrastructure. To aid the developer, analyst, or other user working with the model 104, filters 106 are provided to extract desired or relevant portions of the (perhaps very large) model 104. A view of this extracted portion can then be presented to the requesting or another user, often via interface 142. The extracted portion of model 104 from one filter 106 can be intersected or aggregated with extracted portions from other filters to generate a unified view on the subset. These filters 106 may include any number of appropriate criteria including user technical level (e.g., developer, analyst, end user), user role (e.g., clerk, manager, administrator), portion of business logic (e.g., approval, compensation), third party elements vs. internal flag, business department (e.g., warehouse, accounts payable, human resources), decision points, UI or data flow, and so on. It will be understood that filters 106 may be native to server 108, modeling environment 116, or business application 124 or provided by the requesting or another user as appropriate. For example, the user may utilize a filter 106 provided by modeling environment 116 to drill down to a more manageable subset. This example user may then provide customized criteria or filters 106 to focus on particular portions of this subset.

Some or all of the data objects 102, models 104, and filters 106 may be stored or referenced in a local or remote development or metamodel repository. This repository may include parameters, pointers, variables, algorithms, instructions, rules, files, links, or other data for easily providing information associated with or to facilitate modeling of the particular object. More specifically, each repository may be formatted, stored, or defined as various data structures in eXtensible Markup Language (XML) documents, text files, Virtual Storage Access Method (VSAM) files, flat files, Btrieve files, comma-separated-value (CSV) files, internal variables, one or more libraries, or any other format capable of storing or presenting all or a portion of the interface, process, data, and other models or modeling domains. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

In addition to memory, illustrated server 108 includes example processors 120 and 122. The processors 120 and 122 may each be a central processing unit (CPU), a blade, an application specific integrated circuit (ASIC), or a field-programmable gate array (FPGA). Both processors (120 and 122) may execute instructions and manipulate data to perform the operations of server 108. Although FIG. 1 illustrates two processors (120 and 122) in server 108, only one or more than two processors may be used according to particular needs, desires, or particular embodiments of environment 100. In the illustrated embodiment, processor 120 executes model-driven development tool (or environment) 116 and processor 122 executes modeled business application 124. At a high level, the modeling environment 116 and application 124 are operable to receive and/or process requests from developers and/or users and present at least a subset of the results to the particular user via an interface.

The GUI modeling environment 116 may be any development tool, toolkit, application programming interface (API), application, or other framework that allows a developer to develop, configure, and utilize various business elements that can be more easily modeled during modeling (or during design time) of a particular business application. For example, the model-driven framework or environment may allow the developer to use simple drag-and-drop techniques to develop pattern-based or freestyle user interfaces and define the flow of data between them. Such drag and drop techniques may include selecting, inputting, identifying, or some other indication that the developer is interested in a particular object or element. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding; in other words, the modeling environment can be used to create, modify, and examine the model.

In some cases, this example modeling environment 116 may provide a personalized, secure interface that helps unify enterprise applications, information, and processes into a coherent, role-based portal experience. Further, the modeling environment may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment may provide a shared set of services for finding, organizing, and accessing unstructured content stored in third-party repositories and content management systems across various networks 112. Classification tools may automate the organization of information, while subject-matter experts and content managers can publish information to distinct user audiences. Regardless of the particular implementation or architecture, this modeling environment may allow the developer to easily model various elements using this model-driven approach. As described in more example detail later, the model is deployed, and environment 100 may translate the model into the required code for at least one application 124 or web service. This deployed business application 124 may then be modified or enhanced as appropriate using the modeling environment 116.

More specifically, application 124 may represent any modeled software or other portion of business functionality or logic. A first instance of application 124 may represent a first application that is .NET-based, while a second instance of application 124 may be a similar hosted web-based solution. In yet another example, application 124 may be a modeled composite application with any number of portions that may be implemented as Enterprise Java Beans (EJBs) or the design-time components may have the ability to generate run-time embodiments into different platforms, such as J2EE, ABAP (Advanced Business Application Programming) objects, or Microsoft's .NET. In a further example, application 124 may merely be a modeled and published web service. Further, while illustrated as internal to server 108, one or more processes associated with modeling environment 116 or application 124 may be stored, referenced, or executed remotely. For example, a portion of an application may be a web service that is remotely called, while another portion of the application may be an interface object bundled for processing at remote client 110. Moreover, modeling environment 116 or application 124 may each be a child or sub-module of other respective software modules or enterprise applications (not illustrated) without departing from the scope of this disclosure.

Regardless of the particular implementation, “software” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as a single module that implements the various features and functionality through various objects, methods, or other processes, the software may instead include a number of sub-modules, third party services, components, libraries, and such as appropriate. Conversely, the features and functionality of various components can be combined into single components as appropriate.

Server 108 may also include interface 117 for communicating with other computer systems, such as clients 110, over network 112 in a client-server or other distributed environment. In certain embodiments, server 108 receives data from internal or external senders through interface 117 for storage in memory 105 and/or processing by processor 120 or processor 122. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals. Interface 117 may allow communications across network 112 via a virtual private network (VPN), SSH (Secure Shell) tunnel, or other secure network connection.

Network 112 facilitates wireless or wireline communication between computer server 108 and any other local or remote computer, such as clients 110. Network 112 may be all or a portion of an enterprise or secured network. In another example, network 112 may be a VPN merely between server 108 and client 110 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 108 and at least one client 110. In other words, network 112 encompasses any internal or external network, networks, sub-network, or combination thereof operable to facilitate communications between various computing components in environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain local or remote clients 110.

Client 110 is any computing device operable to connect or communicate with server 108 or network 112 using any communication link. At a high level, each client 110 includes or executes at least GUI 142 and comprises an electronic computing device operable to receive, transmit, process and store any appropriate data associated with environment 100. It will be understood that there may be any number of clients 110 communicably coupled to server 108. Further, “client 110,” “developer,” and “user” may be used interchangeably as appropriate without departing from the scope of this disclosure. Moreover, for ease of illustration, each client 110 is described in terms of being used by one user. But this disclosure contemplates that many users may use one computer or that one user may use multiple computers. As used in this disclosure, client 110 is intended to encompass a personal computer, touch screen terminal, workstation, network computer, kiosk, wireless data port, smart phone, personal data assistant (PDA), one or more processors within these or other devices, or any other suitable processing device. For example, client 110 may be a PDA operable to wirelessly connect with external or unsecured network. In another example, client 110 may comprise a laptop that includes an input device, such as a keypad, touch screen, mouse, or other device that can accept information, and an output device that conveys information associated with the operation of server 108 or clients 110, including digital data, visual information, or GUI 142. Both the input device and output device may include fixed or removable storage media such as a magnetic computer disk, CD-ROM, or other suitable media to both receive input from and provide output to users of clients 110 through the display, namely, the client portion of GUI or application interface 142.

GUI 142 comprises a graphical user interface operable to allow the user of client 110 to interface with at least a portion of environment 100 for any suitable purpose, such as viewing application, model, or model subset (view) data 144. As the models 104 are filtered, at least a viewable portion of the results 144 are presented using GUI 142. Generally, GUI 142 provides the particular user with an efficient and user-friendly presentation of data provided by or communicated within environment 100. More specifically, GUI 142 can include a modeling editor that presents views of models 104 based upon filters. The modeling editor can be connected with the modeling environment 116 (or other development environment) such that the modeling editor and/or the modeling environment 116 can automatically generate an application model (e.g., a model of an application that is being developed) from a graphical model and/or vice versa. The modeling editor can allow a user to freely choose graphical objects that can represent one or more development objects, or no development objects at all. The modeling editor can support representing different abstraction levels that correspond to a graphical model. For example, this modeling editor can support modeling a detailed view or an abstract view of a graphical model. Typically, the information that is represented in a graphical model can be freely edited. For example, a graphical model can be edited to include user-descriptions or business information that is not part of the development objects and/or relationships among development objects. Changes to development objects and/or relationships among development objects can be automatically reflected in an associated graphical model, and/or vice versa. Accordingly, GUI 142 may comprise a plurality of customizable frames or views having interactive fields, pull-down lists, and buttons operated by the user. GUI 142 may also present a plurality of portals or dashboards. For example, GUI 142 may display a portal that allows developers or information managers to view, create, and manage data objects 102 or models. GUI 142 is often configurable, supporting a combination of tables and graphs (bar, line, pie, status dials, etc.) and is able to build real-time dashboards. It should be understood that the term “graphical user interface” may be used in the singular or in the plural to describe one or more graphical user interfaces and each of the displays of a particular graphical user interface. Indeed, reference to GUI 142 may indicate a reference to the front-end or a component of any application or software, as well as the particular interface accessible via client 110, as appropriate, without departing from the scope of this disclosure. Therefore, GUI 142 contemplates any graphical user interface, such as a generic web browser or touchscreen, that processes information in environment 100 and efficiently presents the results to the user. Server 108 can accept data from client 110 via the web browser (e.g., Microsoft Internet Explorer or Mozilla Firefox) and return the appropriate HTML or XML responses to the browser using network 112.

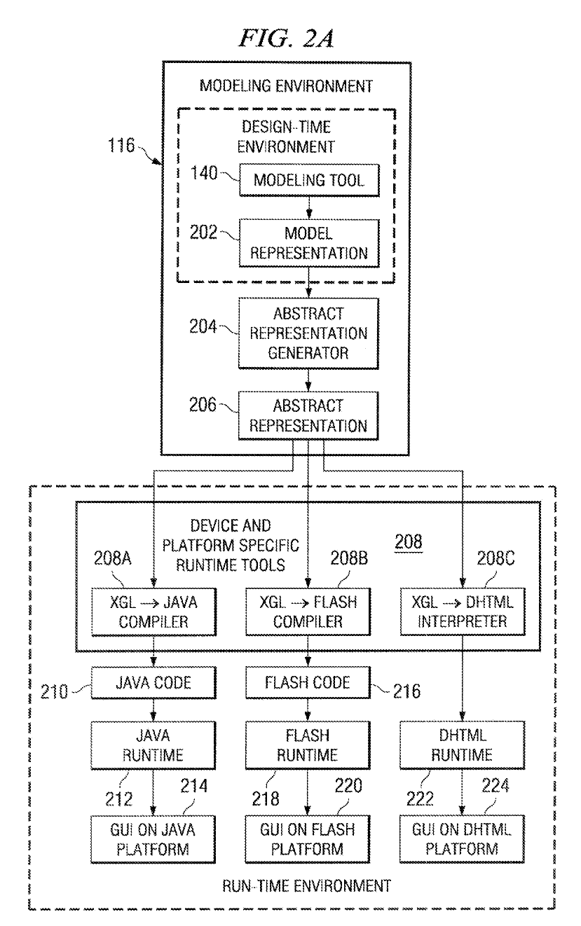

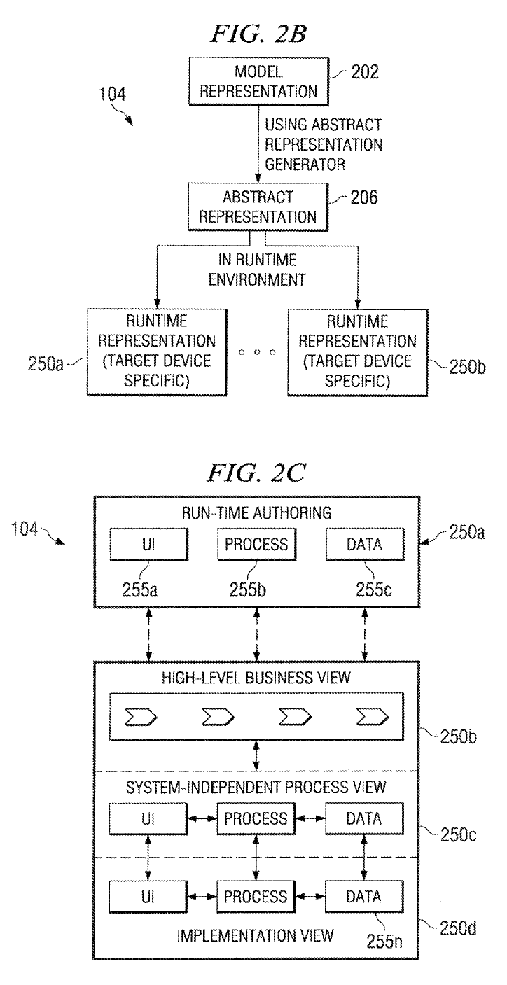

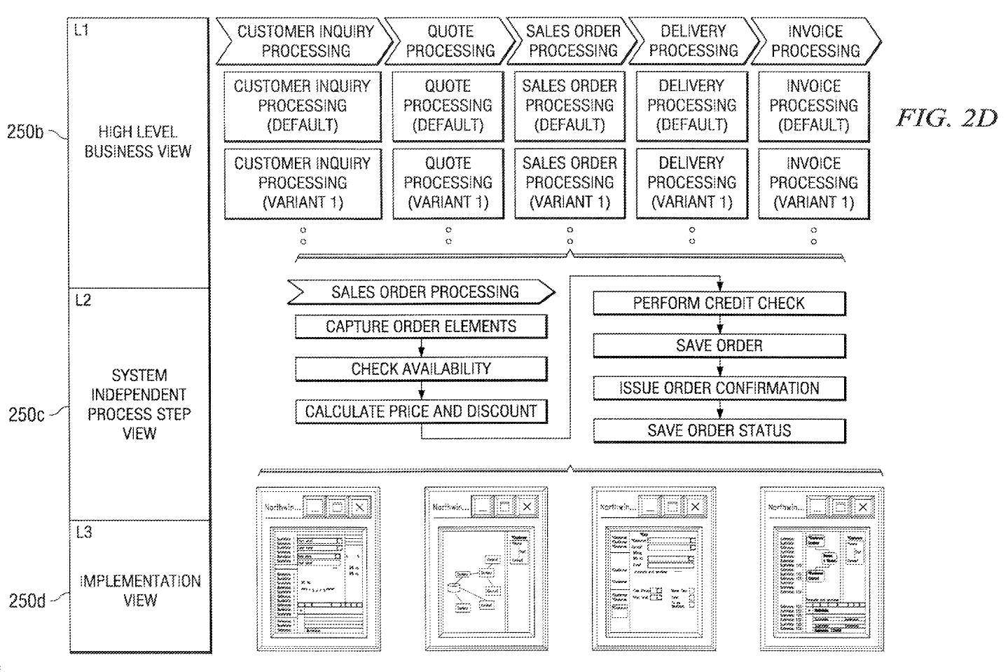

FIG. 2A depicts a more detailed example modeling environment 116 in accordance with one embodiment of the present disclosure. Such a modeling environment 116 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

In certain embodiments, the modeling environment 116 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features, including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 2A, modeling tool 140 may be used by a GUI designer or business analyst during the application design phase to create a model representation 202 for a GUI application. It will be understood that modeling environment 116 may include or be compatible with various different modeling tools 140 used to generate model representation 202. This model representation 202 may be a machine-readable representation of an application or a domain specific model. Model representation 202 generally encapsulates various design parameters related to the GUI such as GUI components, dependencies between the GUI components, inputs and outputs, and the like. Put another way, model representation 202 provides a form in which the one or more models can be persisted and transported, and possibly handled by various tools such as code generators, runtime interpreters, analysis and validation tools, merge tools, and the like. In one embodiment, model representation 202 maybe a collection of XML documents with a well-formed syntax.

Illustrated modeling environment 116 also includes an abstract representation generator (or XGL generator) 204 operable to generate an abstract representation (for example, XGL representation or XGL-compliant representation) 206 based upon model representation 202. Abstract representation generator 204 takes model representation 202 as input and outputs abstract representation 206 for the model representation. Model representation 202 may include multiple instances of various forms or types depending on the tool/language used for the modeling. In certain cases, these various different model representations may each be mapped to one or more abstract representations 206. Different types of model representations may be transformed or mapped to XGL representations. For each type of model representation, mapping rules may be provided for mapping the model representation to the XGL representation. 206. Different mapping rules may be provided for mapping a model representation to an XGL representation.

This XGL representation 206 that is created from a model representation may then be used for processing in the runtime environment. For example, the XGL representation 206 may be used to generate a machine-executable runtime GUI (or some other runtime representation) that may be executed by a target device. As part of the runtime processing, the XGL representation 206 may be transformed into one or more runtime representations, which may indicate source code in a particular programming language, machine-executable code for a specific runtime environment, executable GUI, and so forth, that may be generated for specific runtime environments and devices. Since the XGL representation 206, rather than the design-time model representation, is used by the runtime environment, the design-time model representation is decoupled from the runtime environment. The XGL representation 206 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 206 generated for a model representation 202 is generally declarative and executable in that it provides a representation of the GUI of model 202 that is not dependent on any device or runtime platform, is not dependent on any programming language, and unambiguously encapsulates execution semantics for the GUI. The execution semantics may include for example, identification of various components of the GUI, interpretation of connections between the various GUI components, information identifying the order of sequencing of events, rules governing dynamic behavior of the GUI, rules governing handling of values by the GUI, and the like. The abstract representation 206 is also not GUI runtime-platform specific. The abstract representation 206 provides a self-contained, closed, and deterministic definition of all aspects of a graphical user interface that is device independent and language independent.

Abstract representation 206 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), and the GUIs generated by the devices are consistent with each other in their appearance and behavior.

Abstract generator 204 may be configured to generate abstract representation 206 for models of different types, which may be created using different modeling tools 140. It will be understood that modeling environment 116 may include some, none, or other sub-modules or components as those shown in this example illustration. In other words, modeling environment 116 encompasses the design-time environment (with or without the abstract generator or the various representations), a modeling toolkit (such as 140) linked with a developer's space, or any other appropriate software operable to decouple models created during design-time from the runtime environment. Abstract representation 206 provides an interface between the design time environment and the runtime environment. As shown, this abstract representation 206 may then be used by runtime processing.

As part of runtime processing, modeling environment 116 may include various runtime tools 208 and may generate different types of runtime representations based upon the abstract representation 206. Examples of runtime representations include device or language-dependent (or specific) source code, runtime platform-specific machine-readable code, GUIs for a particular target device, and the like. The runtime tools 208 may include compilers, interpreters, source code generators, and other such tools that are configured to generate runtime platform-specific or target device-specific runtime representations of abstract representation 206. The runtime tool 208 may generate the runtime representation from abstract representation 206 using specific rules that map abstract representation 206 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 206 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 2A, an XGL-to-Java compiler 208a may take abstract representation 206 as input and generate Java code 210 for execution by a target device comprising a Java runtime 212. Java runtime 212 may execute Java code 210 to generate or display a GUI 214 on a Java-platform target device. As another example, an XGL-to-Flash compiler 208b may take abstract representation 206 as input and generate Flash code 216 for execution by a target device comprising a Flash runtime 218. Flash runtime 218 may execute Flash code 216 to generate or display a GUI 220 on a target device comprising a Flash platform. As another example, an XGL-to-DHTML (dynamic HTML) interpreter 208c may take abstract representation 206 as input and generate DHTML statements (instructions) on the fly which are then interpreted by a DHTML runtime 222 to generate or display a GUI 224 on a target device comprising DHTML platform.

It should be apparent that abstract representation 206 may be used to generate GUIs for Extensible Application Markup Language (XAML) or various other runtime platforms and devices. The same model representation 206 may be mapped to various runtime representations and device-specific and runtime platform-specific GUIs. In general, in the runtime environment, machine executable instructions specific to a runtime environment may be generated based upon the abstract representation 206 and executed to generate a GUI in the runtime environment. The same XGL representation may be used to generate machine executable instructions specific to different runtime environments and target devices.

According to certain embodiments, the process of mapping a model representation 202 to an abstract representation 206 and mapping an abstract representation 206 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 206 rather than model representation 202 for runtime processing, the model representation 202 that is created during design-time is decoupled from the runtime environment. Abstract representation 206 thus provides an interface between the modeling environment and the runtime environment. As a result, changes may be made to the design time environment, including changes to model representation 202 or changes that affect model representation 202, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 2B depicts an example process for mapping a model representation 202 to a runtime representation using the example modeling environment 116 of FIG. 2A or some other modeling environment. Model representation 202 may comprise one or more model components 104 and associated properties that describe a modeling domain, such as interfaces, processes, and data. The abstract representation 206 is generated based upon model representation 202. Abstract representation 206 may be generated by the abstract representation generator 204. Abstract representation 206 comprises one or more abstract GUI components and properties associated with the abstract GUI components. As part of generation of abstract representation 206, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 250a, including GUIs for specific runtime environment platforms, may be generated from abstract representation 206. A device-dependent runtime representation may be generated for a particular type of target device platform to be used for executing and displaying the GUI encapsulated by the abstract representation. The GUIs generated from abstract representation 206 may comprise various types of GUI elements such as buttons, windows, scrollbars, inputs boxes, etc. Rules may be provided for mapping an abstract representation to a particular runtime representation. Various mapping rules may be provided for different runtime environment platforms.

For one example implementation, FIG. 2C depicts model 104 associated with business application 124. Specifically, model 104 includes various logical layers that may be loosely or tightly bound, whether static or at runtime. As mentioned above, the logical layers represent different layers of abstraction for the particular model. For example, illustrated model 104 includes a run-time authoring layer 250a, a high level business layer 250b, a system-independent layer 250c, and an implementation layer 250d. Of course, these layers are for example purposes only and other implementations may include, for example, more layers 250, two layers (say system-independent layer 250c, and implementation layer 250d), or one multi-domain layer (say implementation layer 250d). For example, FIG. 2D illustrates one representation of each of several model layers 250 of FIG. 2C. In this example, the high level business view of particular business logic includes customer inquiry processing, quote processing, sales order processing, delivery processing, and invoice processing. Each of these business logic components can then have a more detailed view in the second layer. For instance, illustrated sales order processing comprises a number of processing steps, namely capture order elements, check availability, calculate price and discount, perform credit check, save order, issue order confirmation, and save order status. In other words, each component in the high level first layer can then be drilled down to discover more detailed processing steps that utilized or followed regardless of the particular system that implements the business application 124. FIG. 2D then shows an even more detailed third layer, the implementation view, that shows various specific details for one instance of the process step view. For example, this implementation view depicts various screens that may be presented to client 110, which may indicate that these particular components are part of an interface modeling domain in this layer.

Regardless of the particular number of layers, each layer can—and typically does—include one or more modeling domains. These modeling domains may represent different technical or conceptual aspects of the particular layer. For example, the illustrated layers include a user interface (UI) modeling domain, a business process modeling domain, and a data modeling domain. In some situations, each of the modeling domains may be considered a separate, but logically associated, model in its own right. In other words, the process modeling domain may represent a business process model for all or a portion of a particular business application 124, while the data modeling domain represents a data model of that respective business application 124 (or portion thereof).

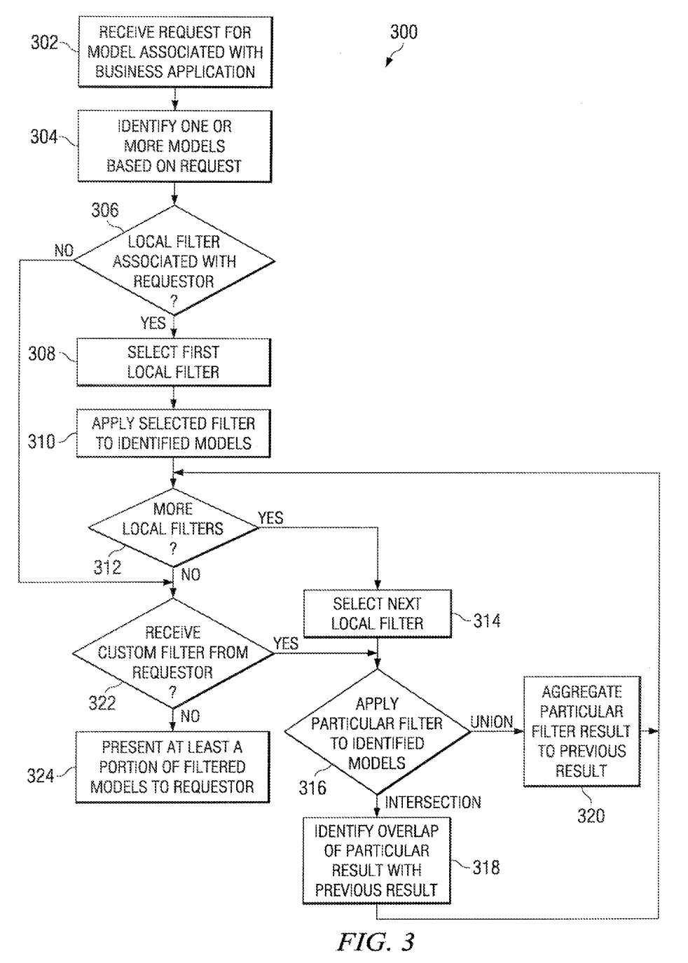

Turning to FIG. 3, FIG. 3 is a flowchart illustrating example method 300 for horizontal and vertical filtering of business application models within example environment 100 of FIG. 1. While the flowcharts illustrate one particular embodiment of environment 100 and modeling environment 116, this disclosure contemplates using any appropriate combination and arrangement of logical elements to implement some or all of the described functionality.

At a high level, method 300 describes one particular implementation for identifying one or more models 104 (or modeling layer or domains), filtering the identifying models 104, and presenting some portion of the filter results to client 110. Illustrated method 300 begins at step 302, where modeling environment 116 receives a request from client 110 for a model 104 associated with business application 124. Next, at step 304, modeling environment 116 identifies one or more models 104 that satisfy the particular request. As described above, model 104 can represent a high level model of multiple layers, one layer of multiple domains, multiple domains from across layers, and so forth. In other words, the identified models 104 may comprise two (tightly or dynamically) bound modeling domains from different layers.

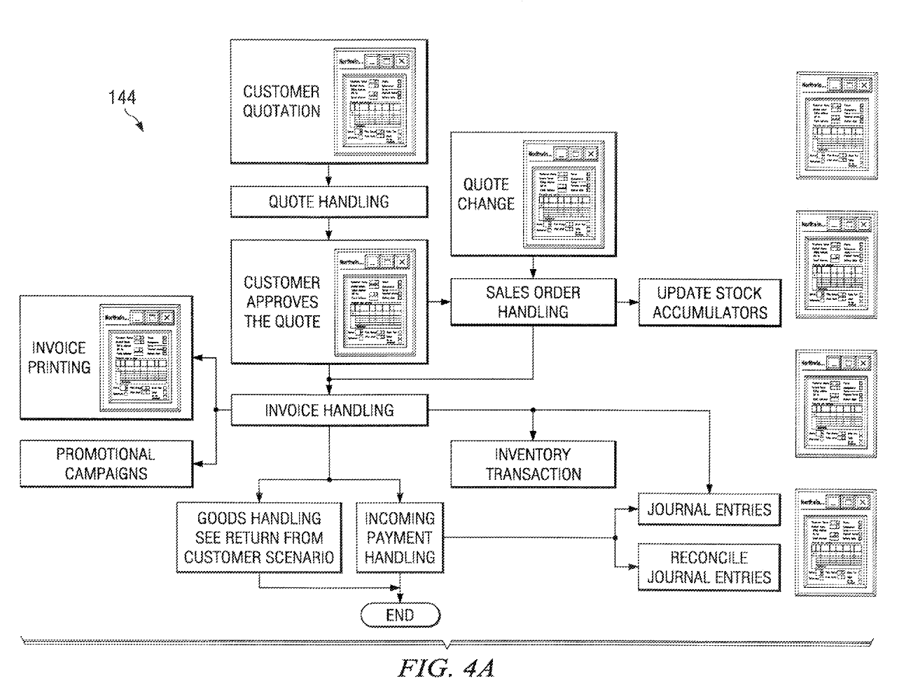

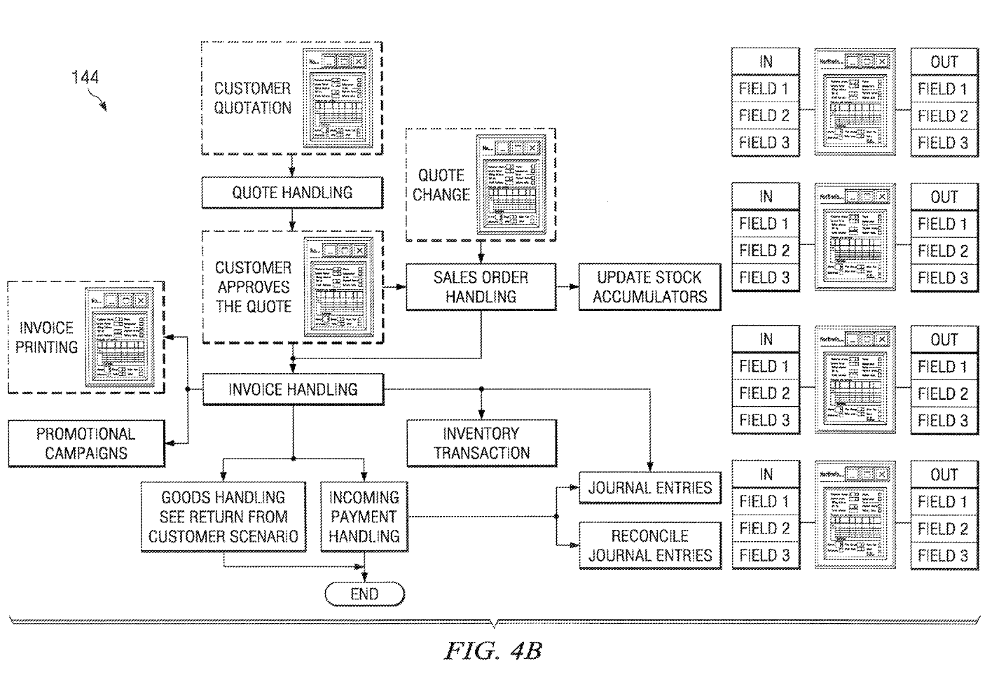

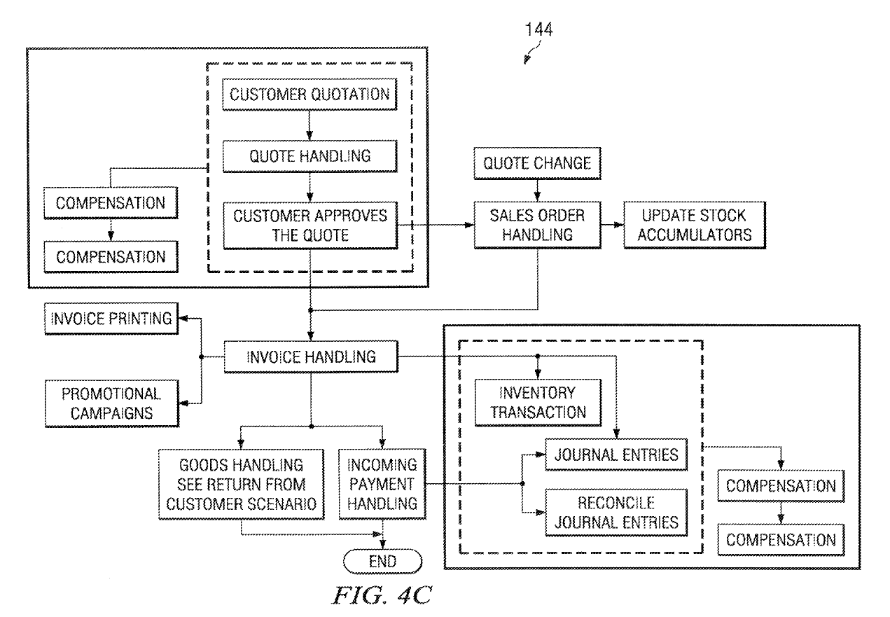

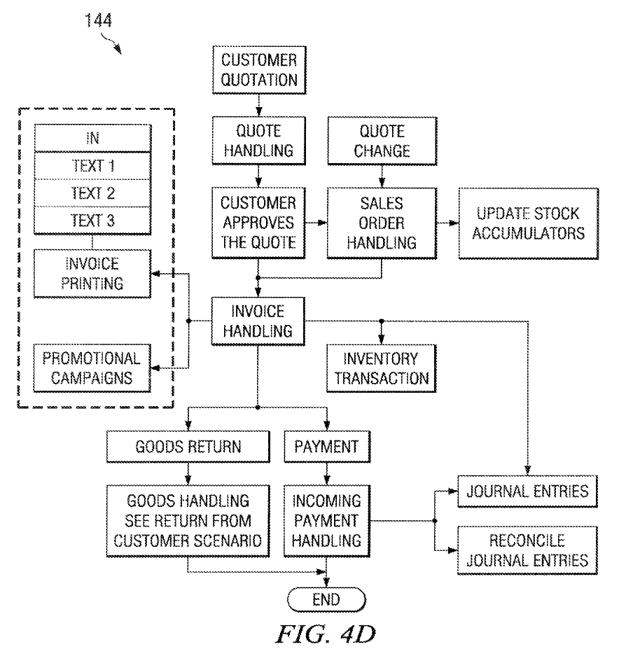

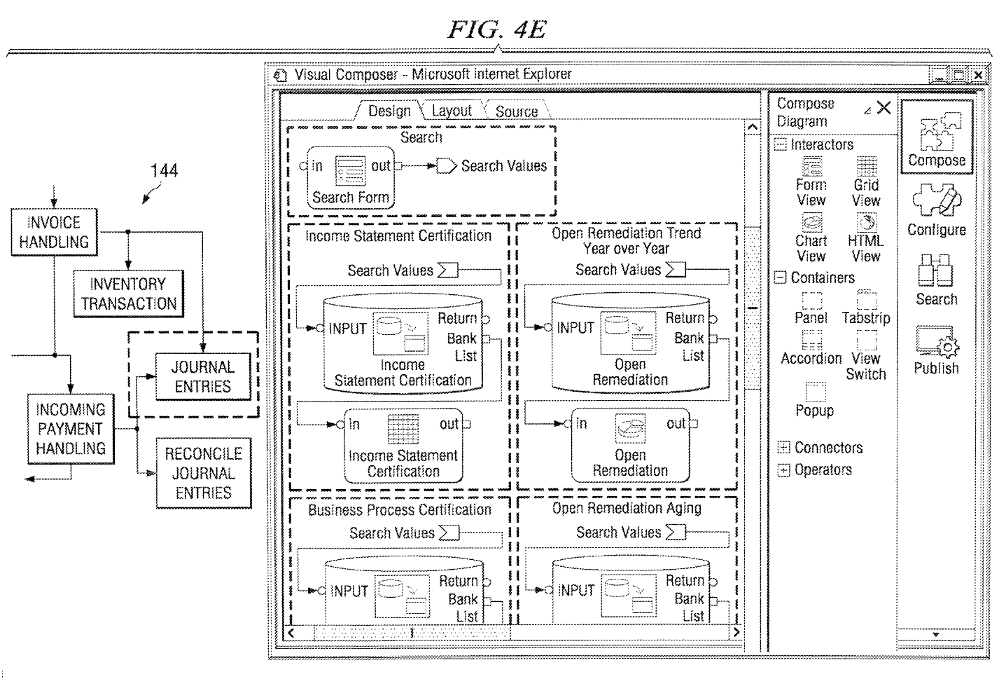

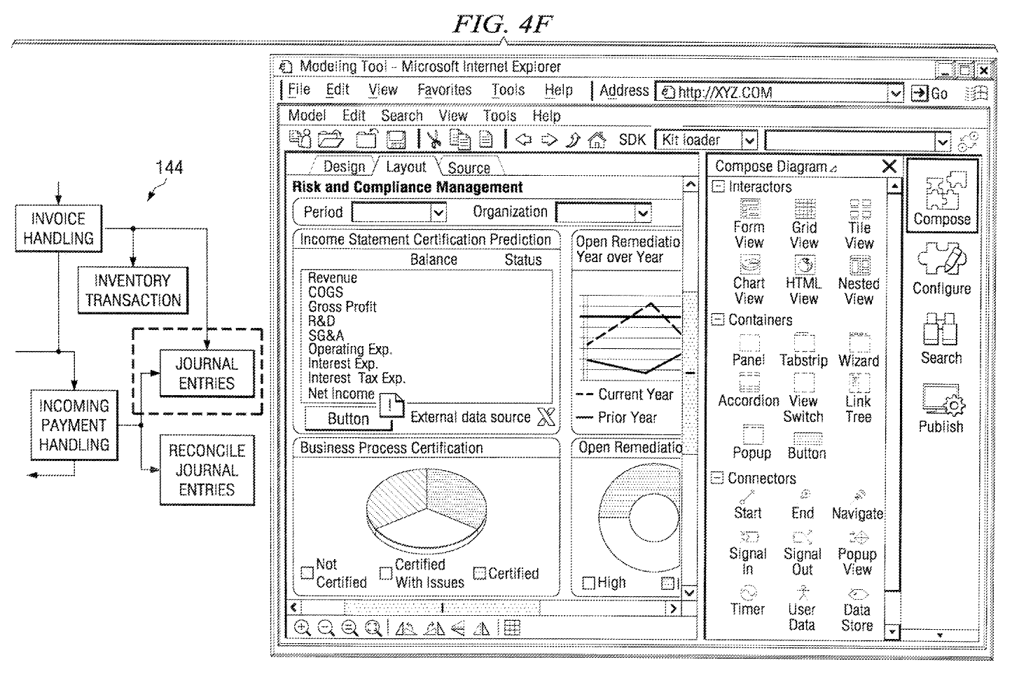

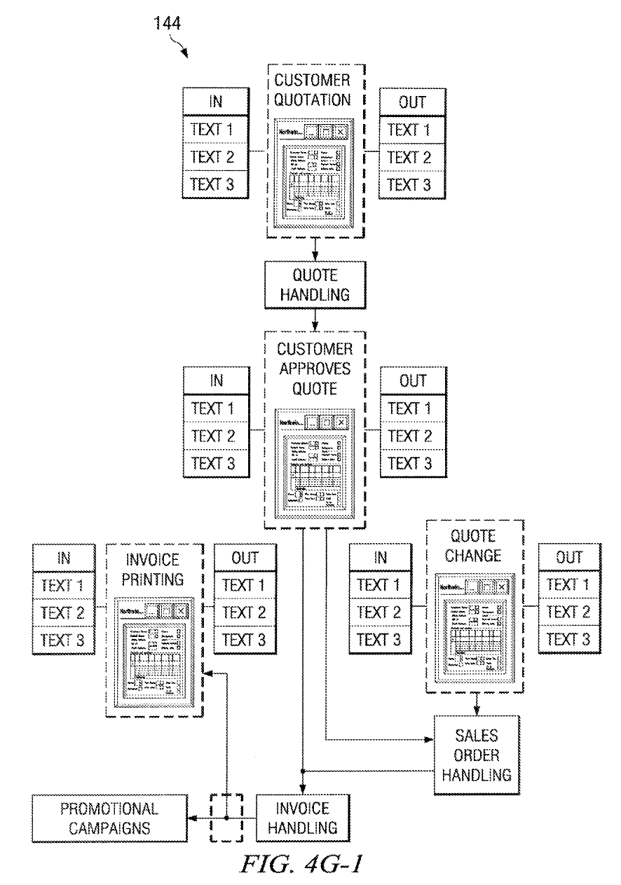

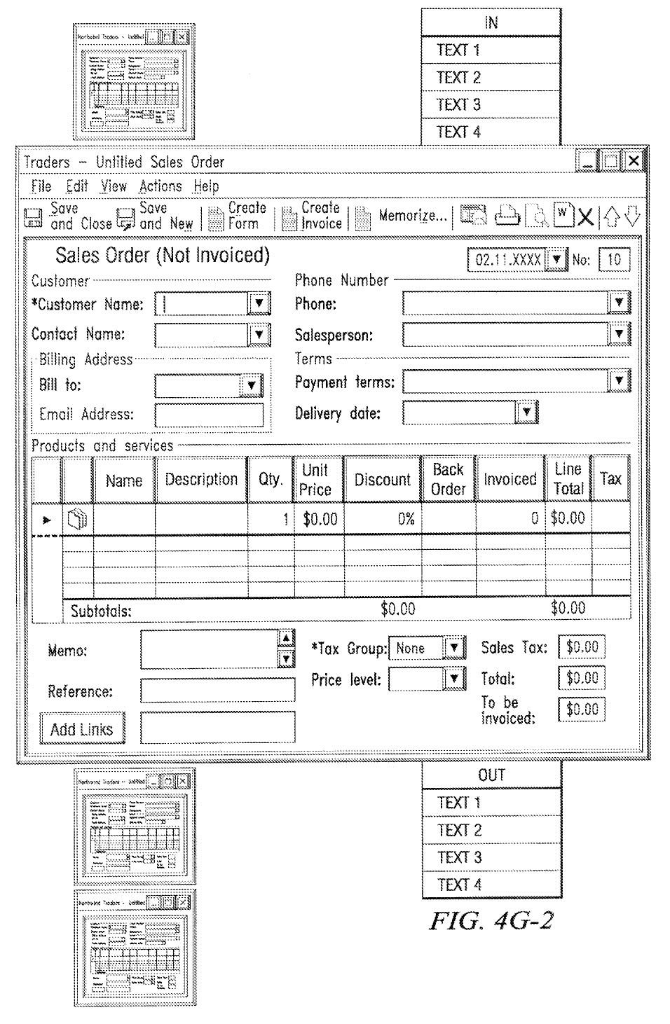

Once modeling environment 116 has identified the one or more models 104 (or currently with such identification), it may then apply any appropriate filters 106, whether local (as in known or determined by modeling environment 116) or custom (as in provided by client 110). In the first instance, modeling environment 116 may determine if one or filters should be automatically or dynamically associated with client 110. To accomplish this, modeling environment 116 may collect, request, or otherwise identify user data, client data, profile or security information, metadata, and so forth to identify matching filter criteria. For example, modeling environment 116 can examine the request (and requestor) to determine a user role, a user technical level, a location, a department, and so forth. Based on this information, modeling environment 116 can select (or offer for client approval) appropriate filters that reduce the model complexity or scope to a level appropriate for such information. If such filters 106 are found, as shown at decisional step 306, the modeling environment 116 selects a first local filter 106 at step 308. Then, at step 310, the selected filter 106 is applied to the identified models at step 310. Typically, this filtering logically extracts m modeling domains, or portions thereof, that satisfy the particular filter criteria. For example, FIG. 4A illustrates horizontal filter 106 that results in particular invoicing business logic and the related interface screens. In some situations, the result may substantially or fully match the target model. For example, if the requester is a highly technical business analyst, then both higher level business logic layers and lower level technical layers may be presented to him. Next, at decisional step 312, modeling environment 116 determines if there are more local filters 106 to apply the currently filtered results.

If there are further filters 106 to apply to the current filtered model, then the next filter is selected at step 314 and applied to the filtered model at step 316. Based upon static parameters and rules or dynamic criteria, modeling environment 116 may determine an intersection of the results or a union. Specifically, if the results are intersected, then modeling environment 116 takes the current filtered model and determines the overlap between the previous result and the current result at step 318. This overlap could then be considered the current filtered model. For example, FIG. 4C provides dual horizontal filters 106 that result in the compensation steps in the particular invoicing business logic. In another example, FIG. 4D extracts or identifies steps associated with third part processing in the invoicing business logic using two horizontal filters 106. Otherwise, if the results are to be combined, then the current filtered results and the previous filter results are aggregated. For example, in FIG. 4B, the displayed result provides both the data modeling domain and the interface modeling domain for the invoicing business logic, each perhaps identified in response to different horizontal filters 106. In another example, FIGS. 4E and 4F illustrate navigation from the second level to the third level of a portion of the invoicing business logic using vertical filters 106—in the case of FIG. 4E, the data modeling domain, while FIG. 4F shows the interface modeling domain. Such processing can continue while more local filters 106 are present and appropriate at decisional step 312. Once the local filters 106 have been processed, modeling environment 116 processes any received (or retrieved) custom filters from client 110 as shown at decisional step 322. Such custom filters 106 may include or utilize any appropriate filter criteria, including those that are present in local filters 106 but are customized for the particular client 110. Once the filtering is complete, the results are then presented to client 110 at step 324. In some cases, the client 110 can traverse the presented view 144 or can modify the particular as appropriate. For example, the client 110 can add fields or data items to a particular view. Based on the binding, these modifications or traversals can be tracked in other modeling domains or layers as shown at FIG. 4G. In some situations, this mirrored processing may not be presented to client 110.

The preceding figures and accompanying description illustrate processes and implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. For example, custom filters 106 may be applied before or concurrently with local filters 106. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. Software for horizontal and vertical filtering of business application models, the software comprising computer-readable instructions operable when executed to:
identify a first modeling domain and a second modeling domain for a business application;
apply a filter to at least the first modeling domain to determine a subset of the first and second modeling domains; and
present the subset of one of the modeling domains to a client.

2. The software of claim 1, the first modeling domain comprising one of a user interface (UI) domain, a business process domain, or a data domain.

3. The software of claim 2, the first modeling domain representing the particular domain in a first logical layer and the second modeling domain representing the particular domain in a second logical layer.

4. The software of claim 2, the first modeling domain representing the particular domain in a first logical layer and the second modeling domain representing one of remaining domains in the first logical layer.

5. The software of claim 1, the first modeling domain representing a particular domain in a first logical layer and the second modeling domain representing the particular domain in a second logical layer.

6. The software of claim 5, each domain in the first layer tightly bound to the respective domain in the second layer.

7. The software of claim 5 further operable to dynamically bind the presented subset of the modeling domain to the respective subset of the other modeling domain in the other logical layer.

8. The software of claim 5 further operable to:
identify a third modeling domain for a business application;
apply the filter to at least the first modeling domain to determine a third modeling domain; and
present the subset of the third modeling domain to the client

9. The software of claim 8, the third modeling domain comprising the particular domain in a third logical layer.

10. The software of claim 8, the third modeling domain comprising another domain in the first logical layer.

11. The software of claim 1, the first modeling domain representing a first domain in a first logical layer and the second modeling domain representing a second domain in the first logical layer.

12. The software of claim 1 further operable to concurrently present the subset of the other modeling domain to the client.

13. The software of claim 1, the filter comprising criteria selected from at least one of the following: user technical level, user role, business logic portion, third party element flag, business department, and decision point flag.

14. The software of claim 1, the filter comprising a client-supplied filter.

15. The software of claim 1 further operable to:
apply a second filter to at least the first modeling domain to determine a second subset of the first and second modeling domains; and
present the second subset of one of the modeling domains to a client.

16. The software of claim 15 further operable to aggregate the subsets into one presentation.

17. The software of claim 15 further operable to determine the union of the two subsets and present only the union to the client.

18. A system for horizontal and vertical filtering of business application models comprising:
memory storing a plurality of modeling domains for a particular business application; and
one or more processors operable to:
identify a first of the modeling domains and a second of the modeling domains for the business application;
apply a filter to at least the first modeling domain to determine a subset of the first and second modeling domains; and
present the subset of one of the modeling domains to a client.

19. The system of claim 18, the first modeling domain comprising one of a user interface (UI) domain, a business process domain, or a data domain.

20. The system of claim 18, the first modeling domain representing a particular domain in a first logical layer and the second modeling domain representing the particular domain in a second logical layer.

21. The system of claim 20, each domain in the first layer tightly bound to the respective domain in the second layer.

22. The system of claim 20, the one or more processors further operable to:
identify a third modeling domain for a business application;
apply the filter to at least the first modeling domain to determine a third modeling domain; and
present the subset of the third modeling domain to the client

23. The system of claim 22, the third modeling domain comprising another domain in the first logical layer.

24. The system of claim 22 further operable to dynamically bind the presented subset of the modeling domain to the respective subset of the other modeling domain in the other logical layer.

25. The system of claim 18, the first modeling domain representing a first domain in a first logical layer and the second modeling domain representing a second domain in the first logical layer.

26. The system of claim 18, the one or more processors further operable to concurrently present the subset of the other modeling domain to the client.

27. The system of claim 18, the filter comprising criteria selected from at least one of the following: user technical level, user role, business logic portion, third party element flag, business department, and decision point flag.
